(19) United States
(12) Patent Application Publication
(10) Pub. No.: US 2023/0054889 A1
(43) Pub. Date: Feb. 23, 2023

(54) AUTOMATICALLY TRACKING A TRAJECTORY OF A VEHICLE

(71) Applicant: VALERANN LTD., Tel Aviv (IL)

(72) Inventors: Ran KATZIR, London (GB); Michael VARDI, Tel Aviv (IL); Lior SIMCHON, Tel Aviv (IL); Ido GLANZ, Tel Aviv (IL); Shahar BAHIRI, Tel Aviv (IL); Avi TEL-OR, Aseret (IL)

(73) Assignee: VALERANN LTD., Tel Aviv (IL)

(21) Appl. No.: 17/789,859

(22) PCT Filed: Dec. 30, 2020
(86) PCT No.: PCT/IL2020/051349

§ 371 Date: Jun. 29, 2022

(30) Foreign Application Priority Data
Jan. 3, 2020 (GB) 2000069.1

(51) Int. Cl. G08G 1/056

(52) U.S. Cl. CPC G08G 1/056

(57) ABSTRACT

A system and a method for automatically tracking location of a vehicle by receiving a plurality of feature vectors transmitted from a plurality of stationary sensors installed along a road. The feature vectors are related to a plurality of vehicles which are in a range of detection of the plurality of the stationary sensors. The method may include clustering a group of feature vectors from the plurality of feature vectors to a monitored vehicle based on a predetermined driving model, determining parameters of the monitored vehicle, calculating a next expected location of the monitored vehicle, receiving a feature vector, matching the feature vector to the monitored vehicle and tracking a trajectory of the monitored vehicle.

### FIELD OF THE INVENTION

The present invention relates generally to traffic monitoring, and more particularly to a method and system for automatically tracing a journey of a vehicle.

### BACKGROUND OF THE INVENTION

Due to the growing prevalence in vehicle accessibility and ownership, the number of vehicles found on highways, roads, motorways and the like is constantly increasing leading to various road safety and traffic management challenges. Traffic control centers currently use data received from sensors such as cameras which allows for measuring or estimating merely overall traffic. Other road-based sensors are focused on specific use cases such as for example, a magnetic loop for counting vehicles, a radar for detecting stopped vehicles and a camera for detecting unusual events. This approach creates very expensive and continuously outdated systems. Other systems use data from vehicles and/or mobile phones of drivers that provide aggregate data which is not accurate to serve as a reliable source of information and cannot be used due to privacy regulations.

There is no solution allowing road operators and road control centers to use a single data source to identify any disruption to traffic or dangerous driving behavior through data analysis. Precise and anonymous tracing of a single vehicle journey may allow road control centers to identify a plurality of road events such as, drivers at risk, dangerous driving, anti-social driving, and the like. The need for a reliable, safe and automated solution for automatically tracking a journey or a trajectory of a vehicle is desirable.

### SUMMARY OF THE INVENTION

Embodiments of the invention may enable automatically and anonymously tracing a journey of a vehicle and identifying a driving pattern of the vehicle in order to identify events such as drivers at risk, dangerous driving, anti-social driving, and any other vehicle related event or traffic event.

Embodiments of the invention may include a system and a method for automatically tracking location of a vehicle by receiving a plurality of feature vectors transmitted from a plurality of stationary sensors installed along a road. The feature vectors are related to a plurality of vehicles which are in a range of detection of the plurality of the stationary sensors. The method may include clustering a group of feature vectors from the plurality of feature vectors to a monitored vehicle based on a predetermined driving model, determining parameters of the monitored vehicle, calculating a next expected location of the monitored vehicle, receiving a feature vector, matching the feature vector to the monitored vehicle and tracking a trajectory of the monitored vehicle.

According to embodiments of the invention, tracking a trajectory of the monitored vehicle includes tracking a trajectory of the monitored vehicle with relation to one or more lanes defined along the road.

Embodiments of the invention may include identifying a driving pattern of the monitored vehicle based on the trajectory of the monitored vehicle and determining whether the driving pattern is in compliance with one or more predetermined rules.

Embodiments of the invention may include determining a toll based on the driving pattern.

According to embodiments of the invention, the plurality of stationary sensors are located in a predetermined order along the road.

Embodiments of the invention may include clustering a group of feature vectors by clustering two or more feature vectors if a distance between the two or more feature vectors is less than a predetermined distance.

Embodiments of the invention may include calculating a position, an acceleration rate and/or speed of the monitored vehicle in real time.

According to embodiments of the invention, the plurality of feature vectors may include measurements detected by one or more sensors from the plurality of stationary sensors. The one or more sensors are from a group consisting of a magnetic sensor, a vibration sensor, an acoustic sensor, a radar and a light sensor.

Embodiments of the invention may include determining an identity of the monitored vehicle by matching the monitored vehicle with information related to the monitored vehicle received from an external source.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same can be carried into effect, reference will now be made, purely by way of example, to the accompanying drawings in which like numerals designate corresponding elements or sections throughout. In the accompanying drawings:

FIG. 1 is a schematic diagram illustrating exemplary non-limiting architecture of a system for automatically tracking a trajectory of a vehicle according to embodiments of the present invention;

FIG. 2 is a flowchart of a method for automatically tracking a trajectory of a vehicle, according to some embodiments of the invention;

FIG. 3 is a schematic graphical diagram illustrating exemplary system for tracking a trajectory of a vehicle according to embodiments of the present invention;

FIG. 4 is a schematic graphical diagram illustrating an exemplary system for tracking a trajectory of a vehicle according to embodiments of the present invention; and

FIG. 5 is a block diagram depicting a computing device, which may be included within an embodiment of a system for automatically tracking a trajectory of a vehicle, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention can be practiced without the specific details presented herein. Furthermore, well known features can have been omitted or simplified in order not to obscure the present invention. With specific reference to the drawings, it is stressed that the particulars shown are by way of example and for purposes of illustrative discussion of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention can be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that can be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units can be at least partially implemented by a computer processor.

The term “feature vector” may be used herein to refer generally to detectable and quantifiable measurements which may be recorded, taken, sensed or sampled for example using discrete and/or interconnected sensing devices from one or more types, and used for subsequent analysis and processing. A feature vector may be represented, characterized by or saved as an array or an ordered list of values. Each value in the feature vector may correspond to a measurement or an attribute of a measurement sensed or detected by one or more sensing devices and/or one or more types of sensing devices. For example, a feature vector may include a list of measurements detected from a plurality of sensors or detectors. The plurality of sensors may include sensors from a single type or sensors from multiple types, kinds or class. A plurality of feature vectors described in embodiments of the invention may be detected by various types of sensors. In the present context, a plurality of different “feature vectors” are collected, clustered and analyzed, generally in correspondence with each other, for the purposes of tracing vehicles. A non-exhaustive list of exemplary sensing devices that their measurements may be collected, either individually or in combination and may be considered “feature vectors”, may include, for example, magnetic field, speed, position, acceleration, sound variation or any combination thereof. Any other measurements may be collected, analyzed and used. Any other type of sensor alone or in combination may be used to detect and transmit one or more feature vectors. When used herein, feature vector may refer to the measurements that make up a feature vector, and also the specific data structure used to store a feature vector.

An exemplary feature vector represented in JavaScript Object Notation (JSON) format may be:

{
“sensor_id”: 124,
“sensor_location_x”: 100,
“sensor_location_y”: 3.3,
“event_timestamp”: 1577702893434,
“x_magnet_signal_strength”: 1000,
“y_magnet_signal_strength”: 300,
“z_magnet_signal_strength”: 500,
“x_magnet_signal_width”: 10,
“y_magnet_signal_width”: 20,
“z_magnet_signal_width”: 30,
“microphone_signal_strength”: 1732,
“microphone_signal_width”: 72,
“microphone_dominant_frequency”: 70,
“light_sensor_strength”: 79,
“radar_object_distance”: 3.2,
“radar_object_speed”: 28,
“radar_object_size”: 12
}

Wherein x, y and z represent directions in a cartesian coordinate system. It should be understood to a person skilled in the art that any number of values from any number of sensors from any type may be included in a feature vector. For example, a sensor according to embodiments of the present invention may include a plurality of sensors from various, numerous, several or different kinds or types of sensors.

A direction of traveling or driving of a monitored vehicle is referred to herein as “X direction” or “X axis” and a direction vertical to the X direction is referred to herein as “Y direction” or “Y axis”.

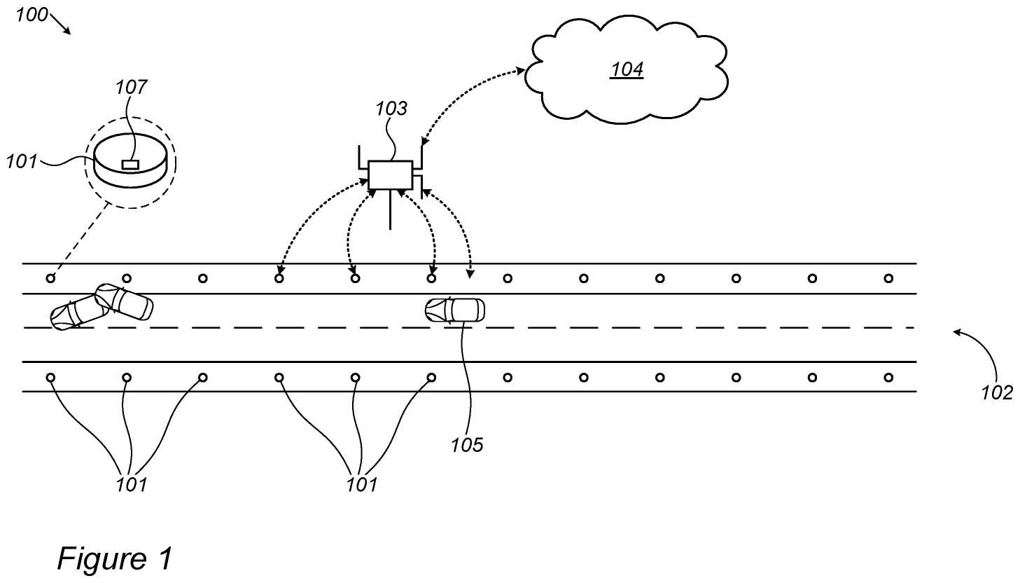

FIG. 1 illustrates exemplary non-limiting architecture of a system for traffic monitoring according to embodiments of the present invention. System 100 may include a plurality of road stud units, also referred to herein as “sensor nodes”, “studs” or “nodes” 101 which may be installed and distributed at substantially uniform intervals e.g., every 9-20 meters, along a road or highway 102. The road stud units may be located at either side of highway 102, of a lane included in highway 102, along marking lines of highway 102, in or within a lane included in highway 102 or in any other boundary location near highway 102. It should be understood to a person skilled in the art that any deployment pattern may be used while installing studs 101 along highway 102 or along lanes included in highway 102.

Each road stud unit 101 is equipped with one or more sensors 107 or detectors operable to record one or more feature vectors associated with vehicles 105 passing proximate to a road stud unit 101 and/or the ambient conditions of highway 102, e.g., weather conditions. As will be appreciated by those skilled in the art, any appropriate sensor/detector may be included within road stud unit 101. A non-exhaustive exemplary list of appropriate sensors/detectors may include, for example, acoustic sensors (e.g., microphone), magnetic field sensors, capacitive sensors, temperature sensors, optical sensors, accelerometers and/or radar sensors.

Each of the plurality of road stud units 101 are communicatively connected, via wired or wireless means, to one or more gateway stations 103. The gateway stations 103 may be interspersed and/or distributed at, for example, intervals of 500-1000 meters. Preferably each gateway station 103 may be operable to communicate with multiple road stud units 101 (e.g., 200 or more road stud units). Each gateway station 103 may be further operable to communicate with passing connected cars using vehicle-to-infrastructure communication. Each gateway station 103 may receive wired or wireless transmission from one or more road stud units 101 which are communicatively connected to it.

Each gateway station 103 is further communicatively connected, via wired or wireless means, to a remote processing facility 104 which may include one or more processors operable to collect information from all gateway stations 103, and optionally also from traffic monitoring infrastructure and/or connected vehicles, and to perform analysis/assessment thereupon. Preferably the communicative connections between road stud units 101, gateway stations 103, and the remote processing facility 104 are achieved wirelessly using one or more data protocols, such as Long Range (LoRa), Global System for Mobile Communications (GSM), Dedicated Short Range Communications (DSRC), The communicative connection between each road stud unit 101 and gateway station 103 may be achieved using Long Range (LoRa) data protocols. The communicative connection between each gateway station 103 and remote processing facility 104 may be achieved using Global System for Mobile Communications (GSM) data protocols. Preferably the remote processing facility 104 is a cloud-based system including one or more processors or any other computing system having on-demand availability. Some embodiments of the invention may allow direct communication between road stud units 101 and remote processing facility 104, e.g., without using gateway station 103 as a mediator. Road stud units 101 may communicatively connected to processing facility 104 via, for example, a cellular network, the Internet or any other communication network.

In some embodiments, one or more gateway station 103 may be further communicatively connected with one or more vehicles 105 (e.g., via a vehicle-to-infrastructure (V2I) link) and/or with one or more external/unassociated tracking/sensing systems (e.g., camera monitoring infrastructure, or the like). It will be appreciated that the one or more vehicle and/or one or more external/unassociated tracking/sensing systems may each include independent sensing equipment, feature vectors from which may be supplied to gateway station 103 and therefrom forwarded to the remote processing facility 104 for subsequent analytics. In alternative embodiments, one or more road stud units 101 may be communicatively connected directly to the remote processing facility 104. In yet further embodiments, one or more gateway stations 103 may be operable to perform, either independently or collaboratively, the functionality of remote processing facility 104. Performing by gateway stations 103 some or all the processing, analysis and/or assessments, performed by processing facility 104 may allow low latency and minimal delay between processing of the information and sending alerts to the vehicles.

Embodiments of the invention may use the distributed road stud units 101 as a dense sensory network to anonymously trace a journey, a route, a way or a path of a specific vehicle 105 along highway 102 and to track or identify precise vehicle driving patterns of the specific vehicle 105. According to embodiments of the invention, a trajectory, path, journey or route of the monitored vehicle may include a list of values which may provide details on where the monitored vehicle is at a certain time and about its speed and acceleration rate at that time. A driving pattern may be based on the tracked trajectory and may include analysis of the tracked trajectory of one or more monitored vehicles, for example, by extracting, learning and concluding meanings and/or insights from tracked trajectory. Exemplary driving patterns may include, identified frequent lane changes, speeding, sudden breaking and the like. Each road stud unit 101 may be equipped with one or more sensors 107 or detectors that may detect or sense one or more measurements in a vicinity of the road stud unit 101. In some exemplary embodiments of the invention, each road stud unit 101 may include one or more sensors, for example, a magnetic sensor, and/or a sound/voice detector e.g., a microphone and/or a vibration sensor, and/or a radar. As a vehicle passes by road stud unit 101, a sensor may send indications regarding the time of the passage and a strength of the detected signal to remote processing facility 104 via gateway station 103.

Processing facility 104 may use signals detected by the plurality of road stud units 101 to calculate, analyze or evaluate a location of a monitored vehicle on highway 102 at a specific time. For example, signals detected by one or more sensors 107 of road stud units 101 located on both sides of a lane indicated on highway 102, may be used to calculate an exact in-lane location of a vehicle on y axis, while signals detected by one or more sensors 107 of road stud units 101 located one after the other on the same side of highway 102, may be used to calculate an exact location along highway 102 on x axis. The exact location may be accurate down to centimeters, e.g., +/−10 centimeters, due to the deployment of road stud units 101 which may be distributed in relatively small distances between consecutive pairs road stud units 101.

Processing facility 104 may receive a plurality of feature vectors transmitted from a plurality of road stud units 101 installed along a road, the values included in the feature vectors may be transmitted from stationary sensors located withing the plurality of road stud units 101. The feature vectors may be related to a plurality of vehicles which are in a range of detection of the plurality of the stationary sensors included in the plurality of road stud units 101, Processing facility 104 may cluster a group of feature vectors from the plurality of feature vectors to a monitored vehicle based on a predetermined driving model. Clustering may include calculating “a distance between two feature vectors”. A “distance between two feature vectors”, also referred to herein as “distance” may be a weighted score function based on values of two feature vectors. It should be understood to a person skilled in the art that any function, formula or method may be used to define such a “distance”. For example, a “distance between two feature vectors” may be defined as a weighted sum of squared differences between corresponding values in two feature vectors. Facility 104 may identify a plurality of feature vectors within a predefined proximity “distance” from each other as a valid cluster which relate to a specific vehicle that behaves according to a predefined set of rules and may determine parameters such as, for example, speed, acceleration rate and a location of the monitored vehicle based on the valid cluster by applying a regression algorithms on the values in the feature vectors included in the valid cluster.

Processing facility 104 may then estimate when the detected vehicle is expected to reach the next pair or set of road stud units by calculating a next expected location of the monitored vehicle. The estimation may be based on a driving model which defines how a vehicle is expected to move on a road and which may include a set of rules and parameters defining the vehicle movement for example, a speed of a vehicle, an acceleration of a vehicle, a distance from a shoulders of a road, a headway between the vehicle and another vehicle and the like. Once the vehicle reaches the next road stud units, a new feature vector may be received by processing facility 104. The new feature vector may be received from one of the road stud units 101 after a valid cluster is identified based on previously received feature vectors. The received feature vector may be matched to the monitored vehicle and may be added to the valid cluster. A journey or a trajectory of the vehicle may be tracked based on values of measurements received from sensors located in consecutive road stud units and saved by processing facility 104. Repeating the detection and the next location calculation may enable tracking a full journey of the vehicle throughout highway 102.

Owing to the substantially uniform distribution of road stud units 101 and the relatively small distance between consecutive pairs (e.g., 10 meter intervals), it is possible to assume that the speed with which a vehicle 105 passes a first road stud unit 101 will be substantially the same as the speed with which it passes a second immediately subsequent road stud unit 101. On the basis of this assumption, a traffic model or driving model may be adapted whereby sensor readings obtained by one road stud unit 101 may be compared with sensor readings obtained by consecutive, following road stud units 101, e.g., a distance or a weighted score function between two consecutive feature vectors may be calculated. Such a model is advantageous as it may minimize the impact of undesirable false detections and noise, thereby yielding higher measurement accuracy than would otherwise be obtainable. Embodiments of the invention may include a large number of road stud units 101 and therefore a large number of sensors 107, e.g., hundreds, thousands, etc., may be used to provide an accurate estimation of the vehicle location.

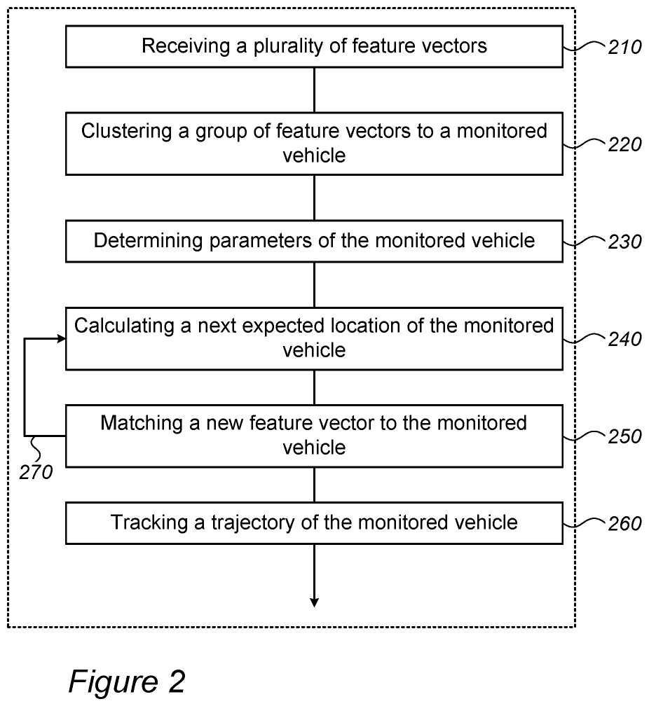

Reference is now made to FIG. 2, which is a flowchart of a method for automatically tracking a trajectory of a vehicle, according to some embodiments of the invention. Operations of the method may be implemented, for example, using system 100, by one or more of the elements in system 100, namely, processing facility 104, road stud units 101, vehicle 105 and gateway station 103 and/or by other suitable units, devices, and/or systems.

As indicated at box 210, an embodiment may include receiving a plurality of feature vectors transmitted from a plurality of stationary sensors installed on road stud units along a road, e.g., located in a predetermined order along the road. The feature vectors may be related to a plurality of vehicles which are in a range of detection of a plurality of the stationary sensors. For example, a plurality of sensors may be located within a plurality of road stud units distributed along a road, e.g., a plurality of sensors 107 installed on road stud units 101 distributed along highway 102 of FIG. 1. Each of the plurality of sensors may be directed to sense, detect or measure a physical attribute and to convert it into a signal. Exemplary sensors may include but are not limited to a magnetic sensor, an acoustic detector e.g., a microphone. a vibration sensor and a light sensor.

According to embodiments of the invention, whenever a vehicle travels in the range of detection of a road stud unit, a feature vector may be produced including one or more features or characteristics of one or more physical attributes measured by one or more sensors located in the road stud units. A feature vector may include a plurality of measurements from a combination of sensors located at a single road stud unit. An exemplary feature vector may include, for example, strength, power, duration, distance, width, direction, time or any other measurement of the detected physical attribute. For example, when a vehicle is getting closer to a sensor included in a road stud unit, the sensor may measure sound signal, when a vehicle may be right above the sensor, or the closest to it as possible, the sound detected may be the strongest, and then, as the vehicle may travel away from the stud unit, the sound may get weaker. The sensor may find the exact time of a peak of the sound signal, and send this time, together with other characteristic of the sound signal, e.g., length, frequency, signature, and the like as values of a feature vector.

Each of the feature vectors received from each of the road stud units may include an array or a list of values detected by sensors included in a certain road stud unit. Each feature vector may include an identification of the specific road stud unit and a time stamp to identify the creation time of the feature vector, e.g., the detection time of the detected signals included in the feature vector. For example, a feature vector may include a location on x axis of a road stud unit which includes sensors, a location on y axis of the road stud unit which includes sensors, a signal strength value of a magnetic sensor, a signal strength value of a microphone sensor, a time stamp indicating when a vehicle passed the road stud unit which includes sensors. Any other measurement of the detected physical attribute may be included in the feature vector. A processing unit, e.g., processing facility 104 of FIG. 1, may receive a plurality of feature vectors transmitted from a plurality of sensors via wired or wireless communication methods. The processing unit may be implemented by hardware and/or software and may receive in real time, multiple feature vectors, associated with multiple vehicles, from multiple sensors.

As indicated at box 220, an embodiment may include clustering, associating or linking a group of feature vectors from the plurality of the received feature vectors to a specific, single monitored vehicle based on a predetermined driving model. A processing unit, e.g., processing facility 104 of FIG. 1, may cluster two or more feature vectors as related to a single monitored vehicle when a calculated “distance” between the feature vectors is within a predefined range defined according to a predefined driving model. According to embodiments of the invention, “a distance” between two feature vectors may be defined as a weighted score function based on values of two feature vectors, e.g., e.g., a weighted sum of squared differences between corresponding values in two feature vectors.

A predetermined driving model may define how a vehicle moves on a road and may include a set of rules and parameters defining the vehicle movement for example, a speed of a vehicle, an acceleration of a vehicle, a distance from a shoulder of a road, a headway between the vehicle and another vehicle and the like. The predetermined driving model may be an adaptive model, e.g., a driving model that may be changed, updated, revised and/or improved over time. Based on the driving model, processing facility may cluster two or more feature vectors. For example, a first feature vector detected by a first road stud unit and a second feature vector detected by a second road stud unit may be clustered together to a valid cluster if a result of a weighted score function between them is less than a predefined threshold. Once the two feature vectors are clustered together, parameters of the vehicle, e.g., speed and location may be computed and a “center” of the cluster may be calculated by, for example, a weighted mean function of all the feature vectors that are already clustered together with parameters extracted from the feature vectors, e.g., time, location, speed, acceleration, class of the vehicle.

Associating may include clustering multiple feature vectors using a predefined proximity measure between values of feature vectors based on a certain driving model. The proximity measure may include a predefined “distance” between the feature vectors or weighted score function based on values of two feature vectors. The clustering process may include clustering two or more feature vectors if a “distance” between the two or more feature vectors is less than a predetermined “distance”. Identifying a plurality of feature vectors within a predefined proximity “distance” from each other according to a predefined model may be considered as a valid cluster which relate to a specific vehicle.

For example, five feature vectors received from five consecutive road stud units may be considered a valid cluster of a first vehicle, if a “distance” between each two feature vectors of the five feature vectors is less than a predetermined “distance” according to a predefined parameters or rules, e.g., all feature vector are related to a vehicle with a certain speed and/or same acceleration rate. When a valid cluster is identified, it may be linked, associated, correlated and/or registered as related to a specific monitored vehicle by saving the two or more feature vectors marked as related to the specific monitored vehicle.

An exemplary clustering process may include receiving two or more feature vectors. Each feature vector may include a plurality of measurements from a plurality of sensors from one or more types, however for simplicity reasons, the exemplary feature vector may include a time (t) when an event has occurred, e.g., a vehicle passed a certain road stud and distance (x), which is the distance between the location of the detecting road stud unit from the first road stud unit that the vehicle passed. A first feature vector may include (t=0 seconds, x=10 meters) and a second feature vector may include (t=1 seconds, x=20 meters). A speed of a monitored vehicle may be defined based on the first and the second feature vectors by using the following equation:

Equation 1: S=(x2−x1)/(t2−t1). The first and second feature vectors may be assumed as derived from a vehicle travels at a speed of 10 meters/second (m/s) calculated based on equation 1: S=(20−10)/(1−0)=10 m/s. A predefined maximum threshold may be defined, for example, as speed (s) of 2 m/s to be used in the decision process whether a next feature vector received should be included in a cluster representing a specific monitored vehicle. For example, a third feature vector may be received and may include (t=2 seconds, x=100 meters). The clustering process may check if this feature vector may match the previous first and second feature vectors in order to decide if the third vector should be added to the cluster representing the monitored vehicle or not.

The calculated speed between example third feature vector and the first feature vector is 45 m/s, calculated using equation 1: (100−10)/(2−0)=45 m/s. As 45 m/s is larger than the speed of the monitored vehicle (10 m/s) by more than the predefined maximum threshold (2 m/s), it may be determined by the clustering process that the third feature vector does not match the first feature vector. The calculated speed between the third feature vector and the second feature vector is 80 m/s, calculated using equation 1: (100-20)/(1-0)=80 m/s. As 80 m/s is larger than the speed of the monitored vehicle (10 m/s) by more than the predefined maximum threshold (2 m/s), it may be determined by the clustering process that the third feature vector does not match the second feature vector. Therefore, it may be determined by the clustering process that the third feature vector may not be added to the cluster representing the monitored vehicle.

Another exemplary, fourth feature vector may be received which may include (t=2.1 seconds, x=30 meters). The calculated speed between the fourth feature vector and the first feature vector is 9.52 m/s, calculated using equation 1: (30-10)/(2.1-0)=9.52 m/s. The calculated speed between the fourth feature vector and the second feature vector is 9.09 m/s, calculated using equation 1: (30-20)/(2.1-1)=9.09 m/s. As the calculated speeds 9.09 m/s and 9.52 m/s are smaller than the speed of the monitored vehicle (10 m/s) by less than the predefined maximum threshold (2 m/s), it may be determined by the clustering process that the fourth feature vector matches the first and second feature vectors. Therefore, it may be determined by the clustering process that the fourth feature vector may be added to the cluster representing the monitored vehicle.

Another exemplary clustering process may include receiving two or more feature vectors that may include the following measurements from a plurality of sensors from one or more types: a position of a vehicle, speed of a vehicle and audio parameters measured by an acoustic sensor, e.g., a microphone. Audio wave may be generated by a vehicle passing by a sensor positioned along a road. Audio parameters may be for example, dominant frequency and peak amplitude of a vehicle passing near a sensor. In this exemplary scenario two vehicles are running side by side in similar speed. A first vehicle may be a private car having, for example, average speed of 90 Kph (Kilometer per hour), dominant audio wave frequency of 800 Hz (Hertz) and audio wave magnitude of 60 dB a (A-weighted decibels) and the second vehicle may be a truck having, for example, average speed of 90 Kph, dominant frequency of 400 Hertz and magnitude of 80 dBa. While the vehicles pass near a road stud unit, multiple feature vectors may be received and processed to create two exemplary clusters which their centers may be represented by the following representations: Cluster 1 center=(90 Kph, 800 Hz, 60 dBa); Cluster 2 center=(90 Kph, 400 Hz, 80 dBa), where cluster 1 relates to the first vehicle (the private car) and cluster 2 relates to the second vehicle (the truck).

When new feature vectors are received from the road stud units as vehicle drive along the road, they may be classified to one of the identified clusters if their “distance” from the center of one of the clusters is less than a predefined maximum threshold (which means they may match to that cluster). For example, a two new feature vectors are received: a first feature vector is composed of Speed=87 Kph, Dominant frequency=850 Hz, Magnitude=62 dBa, and a second feature vector is composed of Speed=93 Kph, Dominant Frequency=470 Hz, Magnitude=75 dBa. According to embodiments of the invention, a “distance” may be calculated by the following equation 2: Equation 2: Distance=absolute (Cluster Center's Speed−Received Speed [Kph])+absolute [(Cluster Center's Dominant Frequency−Received Dominant Frequency)/10 [Hz]]+absolute (Cluster Center's Magnitude−Received Magnitude [dBa]).

The distances to the first and second clusters may be calculated using Equation 2 as follows: a distance of the first received feature vector from cluster 1=abs(87−90)+abs [(850−800)/10]+abs (62−60)=10, a distance of the first received feature vector from cluster 2=abs(87−90)+abs [(850−400)/10]+abs (62−80)=66, a distance of the second received feature vector from cluster 1=abs(93−90)+abs [(470−800)/10]+abs (75−60)=51, and a distance of the second received feature vector from cluster 2=abs(93−90)+abs [(470−400)/10]+abs (75−80)=15. An exemplary predefined maximum threshold may be defined, for example, as “distance” of 20 to be used in the decision process whether a feature vector received should be included in a cluster representing a specific monitored vehicle. In the example, the first received feature vector is matched to the first cluster and the second received feature vector is matched to the second cluster. However, if the distance was calculated, in this example, based only on the speed, the distance of the first received feature vector from both cluster would have been 3, and the distance of the second received feature vector from the two clusters would have been 3 too, therefore the received feature vectors may be matched to the wrong cluster, meaning relate the feature vector origin by the truck to the cluster that is representing the private car and vice versa.

According to embodiments of the invention, whenever a new, next, received feature vector is added to the cluster, the current state of the cluster is updated. It may be defined that a predefined number of related feature vectors may be defined as a valid cluster to be tracked. A clustering algorithm in accordance with embodiments of the invention, may assume a normal, a regular or typical vehicle driving model with some degree of speed and in-lane change. The clustering algorithm may use previous knowledge related to the road and to a normal driving model. For example, knowledge of the road may include lanes mapping from measurements made when installing the system and/or from a third-party database. Normal driving behavior may be deduced from learning over time or by applying behavioral rules over the road topology. Embodiments of the invention may identify irregular driving behaviors by learning “normal” paths over time by tracking a large number of vehicles driving along a certain road.

As indicated at box 230, an embodiment may include determining parameters of the monitored vehicle based on the detected cluster. Embodiments of the invention may include determining speed, acceleration rate and a location of the monitored vehicle in real time by, for example, applying regression algorithms on the values in the feature vectors included in a valid cluster identified at box 220 and creating a model of the detected cluster. The parameters that may be determined based on the valid cluster may also include, for example, speed, acceleration rate and location of the vehicle. All the feature vectors clustered, associated or identified as a valid cluster related to a specific vehicle may be used in a process of estimating or modeling location, speed and acceleration of the detected vehicle along time. The modeling may include applying regression algorithms such an s linear regression or quadratic regression on each of values included in the feature vectors and creating a two-dimensional model, e.g., a linear or a parabolic graph of a dependent variable based on the independent variable extracted from the feature vectors included in the valid cluster.

As indicated at box 240, an embodiment may include calculating a next expected location of the monitored vehicle. Based on the speed, location and acceleration rate determined at box 230, an estimated speed and an estimated direction of driving may be calculated according to the feature vectors clustered as related to the specific vehicle. For example, a next expected location of a vehicle may be estimated using the current location and speed of the vehicle with a predefined degree of freedom to overcome measurement noise, e.g., +−2 meters to second for speed, +−100 milliseconds for time.

As indicated at box 250, an embodiment may include matching or associating a new feature vector to the monitored vehicle. The new feature vector may be a feature vector received from a road stud unit after a valid cluster of the monitored vehicle is identified. When a new feature vector is received from one of the road stud units, a new current location may be calculated and compared with the next expected location of the monitored vehicle calculated at box 240. A new current location of the vehicle may be calculated based on the current received feature vector by calculating the “distance” between the newly received feature vector and a feature vector from the valid cluster, a previously received feature or a feature vector that may represent the valid cluster. Matching a received feature vector with the next expected location of the monitored vehicle may include a compatibility check of the received feature vector to the cluster identified with the monitored. In some embodiments the received feature vector may be matched with the model of a cluster related to a monitored vehicle. According to embodiments of the invention, steps 240 and 250 may be repeatedly performed, as indicated by arrow 270.

When a new feature vector received from the road stud units the processing facility may try to match it with a valid cluster according to the “distance” between that feature vector to the feature vector already include in the valid cluster. In some embodiments the “distance” may be determined by calculating a weighted score function which is based on the values of a new, received feature vector and a feature vector from the valid cluster, e.g., a feature vector that is determined to be a “center” of the valid cluster, which may represent a cluster, for example, a weighted mean function of all the feature vectors that are included in a cluster together with one or more extracted parameters of the vehicle, e.g., time, location, speed, acceleration, class of the vehicle and the like, a calculated average of all the feature vectors included in the valid cluster or any other formula. According to embodiments of the invention, while creating a valid cluster during clustering process indicated at box 220, a “distance” may be calculated between two feature vectors. During matching process indicated at box 250, a received new feature vector may be match to the monitored vehicle, e.g., to a valid, existing cluster by calculating a “distance” between the new or next feature vector received and a feature vector representing the valid cluster, e.g., a center of the valid cluster.

If there are more than one options for matching the new feature vector to a valid cluster, the cluster included the closest feature vector may be selected. If there is no valid cluster to be matched with the new feature vector, a new cluster may be created starting with the new feature vector.

Each new feature vector received from the road stud units may be associated or clustered with one of the monitored vehicles and a new state of the vehicle may be computed. The state may include the location of the vehicle, e.g., a position of the vehicle on X direction, e.g., in meters or other length units counted from a location of a first stud unit. and on Y direction, e.g., in meters or other length units counted from a location of a first stud unit and a shoulder of the road, the speed vector of the vehicle, e.g., a speed of the vehicle on X direction and on Y direction (Vx, Vy), and the acceleration vector of the vehicle e.g., an acceleration of the vehicle on X direction and on Y direction (Ax, Ay), e.g., acceleration vector may be calculated using a second order linear regression on two or more features vectors, e.g., three features vectors included in a valid cluster. Matching between a feature vector and a cluster may be based on proximity between the received feature vector and the expected location of the monitored vehicle, calculated based on a valid cluster as indicated at box 240.

As indicated at box 260, an embodiment may include tracking a journey of a monitored vehicle and/or tracing an entire path or a journey of the monitored vehicle along the road based on the cluster of feature vectors associated with the monitored vehicle. Tracking the monitored vehicle may be performed in real-time, continuously and as long as the monitored vehicle is traveling along a road which may include road stud units. The trajectory, path or journey of each of the monitoring vehicles is computed using multiple points (Xi, Yi) received from the sensors of the road stud units. The cluster of feature vector related to a monitored vehicle may be saved, e.g., in a database, e.g., a database of the processing facility 104 of FIG. 1, allowing tracking the trajectory of the monitored vehicle at any time.

According to embodiments of the invention tracking a state of the monitored vehicle may include calculating a position, a speed and an acceleration rate of the monitored vehicle in real time, namely the processing required for tracking occurs immediately after the monitored vehicle is sensed, e.g., in the order of milliseconds. Determining a location of the monitored vehicle may include computing an exact location of the monitored vehicle on X axis, parallel to the direction of driving of the monitored vehicle, and on Y axis, perpendicular to the direction of driving of the monitored vehicle.

A location of a vehicle along the X axis may be determined according to a location of the stud which its sensors detected that vehicle. A location of a vehicle along the Y axis may be determined by two or more sensors of two or more studs, e.g., road stud units 101 of FIG. 1 located on both sides of a lane or a highway, at an identical position on X axis. When a vehicle passes between two studs located on two opposite sides of a lane at an identical position on X axis, two signals may be detected at a same time, a first may be received from a first stud and the second may be received by the second, opposite stud. Each signal may be detected at a signal strength related to the distance from the sensing sensor. When a vehicle passes between the first and the second opposite studs, two values of signal may be received, a first from the first stud and the second from the second, opposite stud. Based on a ratio between the values the first signal and the second signal a location of the vehicle on Y axis may be estimated or calculated for a specific location of the studs on X axis. For example, if a vehicle passes between a first stud and a second stud and drive closer to the first stud, a signal detected by sensors of the first stud may have higher value than a signal detected by sensors of the second stud. Based on the ratio between the two signals detected a location on Y axis may be calculated and determined.

Some embodiments of the invention may include identifying a driving pattern of the monitored vehicle based on the entire path or trajectory of the monitored vehicle. For example, a driving pattern may include identifying changes in speed, acceleration rate, lanes usage and other driving parameters with relation to external parameters such as time, road structure and the like. Tracing the entire path of the monitored vehicle may include tracing a path of the monitored vehicle with relation to one or more lanes defined along the road. It may be determined based on a predefined set of rules whether the identified driving pattern follows or is in compliance with one or more of the predetermined rules and a toll may be determined based on the driving pattern.

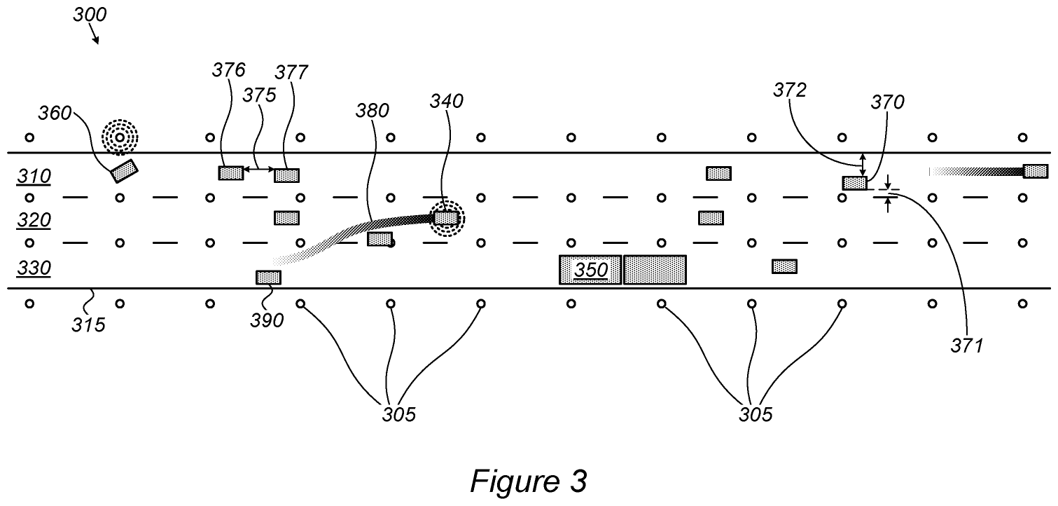

Reference is now made to FIG. 3, which is a schematic graphical diagram illustrating exemplary system for tracking a trajectory of a vehicle according to embodiments of the present invention. Embodiments of the invention may allow collecting data regarding vehicles in order to track a trajectory of a vehicle and to detect or identify incidents or events based on the tracked a trajectory. System 300 may include a plurality of road stud units 305 distributed at substantially uniform intervals along lanes 310, 320 and 330 included in a road or a highway 315. As each of road stud unit 305 may include one or more sensors to collect information regarding vehicles driving on road 315, the multiple sensors may anonymously trace precise vehicle driving patterns according to embodiments of the invention. Embodiments of the invention may allow identifying of driving patterns of each of the monitored vehicles, for example, vehicles 340, 350, 360 and 370.

Tracing precise vehicle trajectory may provide road operators or traffic control systems with a large amount of granular, basic data about every vehicle driving on highway 315, while complying with all privacy regulation, as the data is not personally identifiable. Such data may be used by a road operator to analyze, track and understand traffic trends, identify risks in real time, and even encourage better behavior on the road as described in embodiments of the invention.

Embodiments of the invention may allow identifying incidents or events such as abnormal driving behavior and vehicles that are being driven dangerously and may risk passengers in them or in other vehicles, for example with reference to what was learned and/or violation of standard driving rules with regards to the road topology. For example, embodiments of the invention may identify vehicles that are being driven dangerously, e.g., vehicles that stop in a live lane, vehicles that suddenly depart from the road, vehicles that drive against the direction of traffic, and the like. Some examples for identified incidents or special driving behaviors or patterns are presented with reference to FIG. 3. For example, vehicle 340 journey may be tracked and a crossing from lane 320 to lane 330 may be identified as a dangerous crossing because of proximity to vehicles 380 and 390. A number of lane changes and a level of risk of each of the lane crossings may be calculated. Vehicle 360 journey or trajectory may be tracked and a risk event of a sudden departing from road 315 may be detected. In some embodiments of the invention, different classes of vehicles may be identified by using, for example, a machine learning algorithm which may use features such as signal strength, vehicle speed, magnetic signals and distance signals. Behavior of vehicles may be performed with respect to a class of the vehicle, e.g., vehicle 350 may be identified as a truck or a bus and its driving pattern may be analyzed accordingly. Some embodiments of the invention may allow for collecting traffic statistics information with relation to each of lanes 310, 320 and 330, e.g., how many vehicles used a lane. Some embodiments of the invention may allow measuring of distance 375 between two vehicles 376 and 377, e.g., measure changes in vehicle headway. Some embodiments of the invention may allow detection of a precise in-lane location, e.g., vehicle 370 may be located at a distance 371 from a first end of lane 310 and at a distance 372 from a second end of lane 310.

According to embodiments of the invention, other potential insights, incidents, events and understandings that may be identified by embodiments of the present invention may be related to mechanical issues e.g. identifying abnormal braking, or a sudden acceleration, identifying “non-human” intervention, e.g. when clearly the vehicle behavior is not recognized as a normal driving control. Tracing every individual vehicle may allow also for assessing a risk level of incidents and use the data to predict events and estimate impact of such events on the entire traffic.

According to embodiments of the invention, tracing and recording precise vehicle trajectory may allow further offline processing and analysis. Tracking the trajectory of a monitored vehicle may include offline analyzing of the trajectory of the monitored vehicle for identifying road related information. For example, analyzing and learning from accidents and incidents that may be identified in traced and recorded trajectories. The tracked trajectories of the monitored vehicles may allow precise drawing the routes and behavior of each vehicle involved in an accident or other incident and may provide more data and information on what led to the accident/incident. Embodiments of the invention may allow to perform continues analysis of tracked vehicles over time in order to identify for example, repeating patterns, dangerous spots or areas on a road that may require change, e.g., in road signs, and/or marking and/or construction. For example, on a certain exit from a highway, drivers are used to cross multiple lanes over a short distance which leads to higher probability for accident at this road segment.

Other exemplary offline processing and analysis may include using the tracked and recorded trajectories of monitored vehicles to identify driving patterns of a customer, e.g., a fleet driving patterns that can be used to suggest customized “service package”. For example, if a freight company trucks are commonly using a toll road and it is observed based on the tracked trajectories that trucks may often cause traffic slowdown because they use the fast lane, it may be offered to them to stick to the right lane in rush hours in return for a discount.

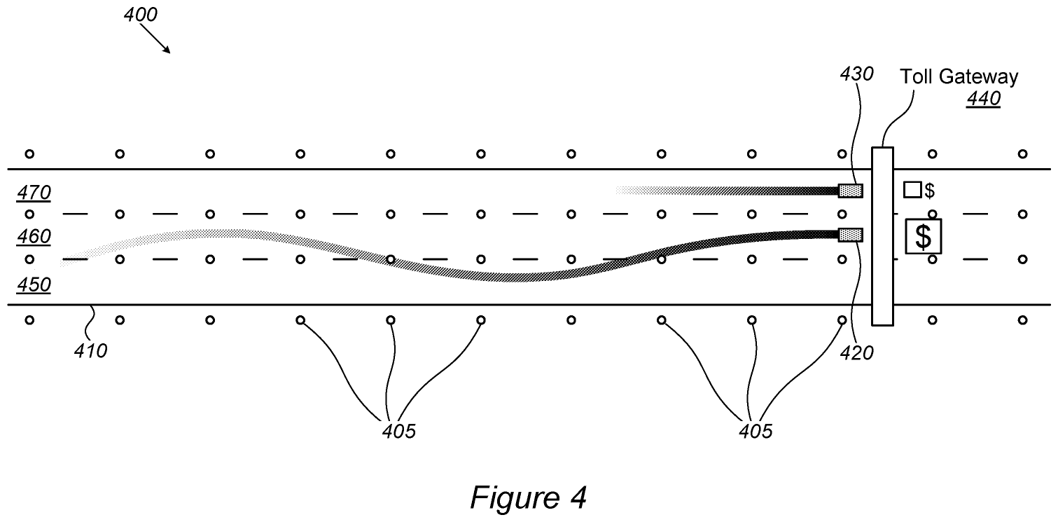

Reference is now made to FIG. 4, which is a schematic graphical diagram illustrating an exemplary system for tracking a trajectory of a vehicle according to embodiments of the present invention. Embodiments of the invention may use the information regarding individual vehicle journeys to encourage a positive driver behavior and improve a control of a detected road by operating systems, insurance companies, municipal authorities and the like. For example, determining accurate tolling per a vehicle journey and implementing advances tolling methodologies that may encourage better driving behavior based on previous behavior of a specific vehicle.

System 400 may include a plurality of road stud units 405 distributed at substantially uniform intervals along lanes 450, 460 and 470 included in a road or a highway 410. A toll booth 440 may be positioned at a certain location on road 410. Embodiments of the invention may track a journey of a monitored vehicle 430 and may measure a time vehicle 430 spent on lane 470 or a distance vehicle 430 drove on lane 470. Such information may be delivered to toll booth 440, e.g., from processing facility 104 of FIG. 1 and when vehicle 430 may reach toll booth 440, the driver may be asked to pay a toll per the exact use of lane 470.

Embodiments of the invention may track a journey of a monitored vehicle 420 and may encourage preferable driving behavior. For example, a journey of a vehicle 420 may include frequent switching between lanes 450 and 460 based on that information, when vehicle 420 may reach toll booth 440, the driver may be asked to pay a penalty toll. Tracing a complete journey of a vehicle may allow to measure or estimate anti-social behavior or non-permitted driving such as frequent lane changes, speeding, sudden breaking, and the like. Having information regarding the complete journey or trajectory of a vehicle may allow to determine a toll, charge or payment correlated to the driver's behavior. For example, a discount may be applied to vehicles that drive in a safe way which is better for overall traffic while a penalty may be applied to vehicles that drive in an unsafe way. The information may be used by road operating systems, insurance companies, municipal authorities and the like.

Embodiments of the invention may allow tracking a journey or a trajectory of a vehicle and identifying one or more driving patterns of the vehicle based on the tracked trajectory. Based on the identified driving patterns it may be determined whether the driving pattern is in compliance with one or more predetermined rules or in accordance with a predetermined or known policies or rules. In some embodiments, the determination regarding the compliance of the identified driving patterns with the predetermined set of rules or policies may be used in a process of determining a road toll or fee to be charged from a driver of the vehicle. Tolling methodologies or any other road management methodologies may be based on the identified driving patterns of the vehicle which is concluded from the tracked journey or a trajectory of a vehicle.

An exemplary tracked trajectory according to embodiments of the invention may include the following exemplary values, records and numbers in the following exemplary structure:

```
trajectory = {
  “start_time” : “2019-12-25 12:00:00.132”,
  “path”: [
    {t = 0, x = 0, y = 2, vx = 10, vy = 0.1, a = 0.01},
    {t = 1.1, x = 10, y = 1.9, vx = 11, vy = 0.05, a = 0.02},
    {t = 2.0, x = 20, y = 1.8, vx = 9, vy = 0.1, a = 0},
    {t = 2.9, x = 30, y = 2.2, vx = 8, vy = −0.05, a = 0.02},
    {t = 4.1, x = 40, y = 2, vx = 10, vy = 0.1, a = 0.01},
    ]
}
```

Wherein “start time” represent a date and time when a trajectory has started to be detected, “t” represents the time lapsed from “start time”, “x” represents a position on x axis in meters counted from a first road stud unit, “y” represents a position on y axis in meters counted from a shoulder of a road or a lane, “vx” represents a speed on x direction in meter/second and “vy” represents a speed on x direction in meter/second, “a” represent acceleration in meter/second\hat{ }2.

The following exemplary driving patterns numbered (1) to (5) may include, driving patterns that may be identified based on tracked trajectories according to embodiments of the invention:

(1) Vehicle 163452 stopped at location x=52, y=0 at time “2019-12-25 23:10:12.132”.
(2) Vehicle 342213 speed was above 150 Kilometer/hour at time “2019-12-25 23:10:12.132”.
(3) Vehicle 3232 spent 20% of its driving time in lane 1 and 80% of its driving time in lane 2.
(4) Vehicle 4433 and vehicle 4233 had an accident at location x=312 m y=3 at time “2019-12-25 23:10:12.132”.
(5) All vehicles reduced their speed at location x=110 between time>“2019-12-25 23:10:12.132” and time<“2019-12-25 35:11:12.132”.

Wherein the numbers following the word “vehicle” represents an identification number of a monitored vehicle, “x” represents a position on x axis in meters counted from a first road stud unit, “y” represents a position on y axis in meters counted from a shoulder of a road or a lane, “time” represents a date and time of the detected event. It should be understood to a person skilled in the art that any other driving pattern may be identified and that any example given is made for clarity purposes only and purely by way of example.

According to embodiments of the invention a monitored vehicle may be traced anonymously, e.g., without knowing any identification parameter of the vehicle or of the driver of the vehicle, e.g., vehicle license plate, driver name, driver's mobile number and the like. In some scenarios it may be valuable to associate the information collected regarding a monitored vehicle to a specific vehicle, driver and/or car owner. Therefore, embodiments of the invention may allow determining an identity of a monitored vehicle by matching the monitored vehicle with information related to the monitored vehicle received from one or more external sources. A road control system may match the information delivered from the road stud units regarding a journey of a vehicle with information from other, external system, for example, a toll gate, Automatic Plate Number Recognition (APNR) system and the like. Other external systems may include systems related to and/or included in the monitored vehicle, e.g., a camera, a receiver, a sensor, a Radio-frequency identification (RFID) reader and the like. The information regarding a monitored vehicle may be matched by comparing, for example, location and speed of a vehicle in multiple time points with location and speed of a vehicle at the same time points as received by external system. Time and a geographical location from a Global Positioning System (GPS) may be used to correlate and match between the monitored vehicle and his identification information from one or more external systems.

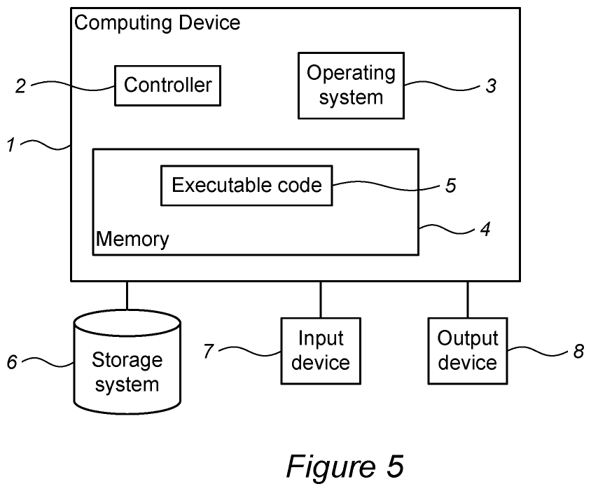

Reference is now made to FIG. 5, which is a block diagram depicting a computing device, which may be included within an embodiment of a system for automatically tracking a trajectory of a vehicle, according to some embodiments of the invention. Computing device 1 may include a controller 2 that may be, for example, a central processing unit (CPU) processor, a chip or any suitable computing or computing device, an operating system 3, a memory 4, executable code 5, a storage system 6, input devices 7 and output devices 8. Controller 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention. For example, a version of computing device 1 may be included in or be processing facility 104, vehicle 105, road stud unit 101 and/or gateway station 103 of FIG. 1

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of, possibly different memory units. Memory 4 may be a computer or processor non-transitory readable medium, or a computer non-transitory storage medium, e.g., a RAM.

Executable code 5 may be any executable code, e.g., an application, a program, a process, task or script. Executable code 5 may be executed by controller 2 possibly under control of operating system 3. Although, for the sake of clarity, a single item of executable code 5 is shown in FIG. 5, a system according to some embodiments of the invention may include a plurality of executable code segments similar to executable code 5 that may be loaded into memory 4 and cause controller 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Content may be stored in storage system 6 and may be loaded from storage system 6 into memory 4 where it may be processed by controller 2. In some embodiments, some of the components shown in FIG. 5 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to computing device 1 as shown by blocks 7 and 8.

A system according to some embodiments of the invention may include components such as, but not limited to, a plurality of central processing units (CPU) or any other suitable multi-purpose or specific processors, controllers (e.g., controllers similar to controller 2), microprocessors, microcontrollers, field programmable gate arrays (FPGAs), programmable logic devices (PLDs) or application-specific integrated circuits (ASIC). A system according to some embodiments of the invention may include a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, a smart phone, a tablet device or any other suitable computing device. Where applicable, modules or units described herein, may be similar to, or may include components of, device 1 described herein.

A system according to some embodiments of the invention may include a remote processing facility, e.g., 104 which may include one or more computer processors 1 each having computer readable storage media or a memory 4 having stored thereon instructions that, when executed by said one or more computer processors 1, result in associating a group of feature vectors from the plurality of feature vectors to a monitored vehicle based on a predetermined driving model, determining a location of the monitored vehicle, calculating a next expected location of the monitored vehicle and tracking a state of the monitored vehicle by matching a received feature vector with the next expected location of the monitored vehicle.

In the above description, an embodiment is an example or implementation of the invention. The various appearances of “one embodiment”, “an embodiment”, “certain embodiments” or “some embodiments” do not necessarily all refer to the same embodiments. Although various features of the invention can be described in the context of a single embodiment, the features can also be provided separately or in any suitable combination. Conversely, although the invention can be described herein in the context of separate embodiments for clarity, the invention can also be implemented in a single embodiment. Certain embodiments of the invention may include features from different embodiments disclosed above, and certain embodiments can incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method for automatically tracking a trajectory of a vehicle comprising:
receiving a plurality of feature vectors transmitted from a plurality of stationary sensors installed along a road, wherein the feature vectors are related to a plurality of vehicles which are in a range of detection of said plurality of the stationary sensors;
clustering a group of feature vectors from the plurality of feature vectors to a monitored vehicle based on a predetermined driving model;
determining parameters of the monitored vehicle;
calculating a next expected location of the monitored vehicle;
receiving a feature vector;
matching the feature vector to the monitored vehicle; and
tracking a trajectory of the monitored vehicle.

2. The method of claim 1, further comprises identifying a driving pattern of the monitored vehicle based on the trajectory of the monitored vehicle.

3. The method of claim 1, wherein tracking a trajectory of the monitored vehicle comprises tracking a trajectory of the monitored vehicle with relation to one or more lanes defined along the road.

4. The method of claim 2, further comprises determining whether the driving pattern is in compliance with one or more predetermined rules.

5. The method of claim 2, further comprises determining a toll based on the driving pattern.

6. The method of claim 1, wherein the plurality of stationary sensors are located in a predetermined order along the road.

7. The method of claim 1, wherein clustering a group of feature vectors comprises:
clustering two or more feature vectors if a distance between the two or more feature vectors is less than a predetermined distance.

8. The method of claim 1, wherein determining parameters of the monitored vehicle comprises calculating a position of the monitored vehicle in real time.

9. The method of claim 1, wherein determining parameters of the monitored vehicle comprises calculating a speed of the monitored vehicle in real time.

10. The method of claim 1, wherein determining parameters of the monitored vehicle comprises calculating an acceleration rate of the monitored vehicle in real time.

11. The method of claim 1, wherein the plurality of feature vectors comprise measurements detected by one or more sensors from the plurality of stationary sensors, wherein the one or more sensors are from a group consisting of a magnetic sensor, a vibration sensor, an acoustic sensor, a radar and a light sensor.

12. The method of claim 1, further comprises determining an identity of the monitored vehicle by matching the monitored vehicle with information related to the monitored vehicle received from an external source.

13. The method of claim 1, wherein tracking the trajectory of the monitored vehicle comprises analyzing the trajectory of the monitored vehicle for identifying road related information.

14. A system for automatically tracking a trajectory of a vehicle comprising:
a plurality of stationary sensors installed along a road, to transmit a plurality of feature vectors wherein the feature vectors are related to a plurality of vehicles which are in a range of detection of said plurality of the stationary sensors;
a remote processing facility comprising a processor to:
receive the plurality of feature vectors;
cluster a group of feature vectors from the plurality of feature vectors to a monitored vehicle based on a predetermined driving model;
determine parameters of the monitored vehicle;
calculate a next expected location of the monitored vehicle;
receive a feature vector;
match the feature vector to the monitored vehicle; and
track a trajectory of the monitored vehicle.

15. The system of claim 14, wherein the remote processing facility is to identify a driving pattern of the monitored vehicle based on the trajectory of the monitored vehicle.

16. The method of claim 14, wherein the remote processing facility is to track a trajectory of the monitored vehicle with relation to one or more lanes defined along the road.

17. The system of claim 15, wherein the remote processing facility is to determine whether the driving pattern is in compliance with one or more predetermined rules.

18. The system of claim 15, wherein the remote processing facility is to determine a toll based on the driving pattern.

19. The system of claim 14, wherein the plurality of stationary sensors are located in a predetermined order along the road.

20. The system of claim 14, wherein the remote processing facility is to cluster a group of feature vectors by clustering two or more feature vectors if a distance between the two or more feature vectors is less than a predetermined distance.

21. The system of claim 14, wherein the remote processing facility is to determine parameters of the monitored vehicle by calculating a position of the monitored vehicle in real time.

22. The system of claim 14, wherein the remote processing facility is to determine parameters of the monitored vehicle by calculating a speed of the monitored vehicle in real time.

23. The system of claim 14, wherein the remote processing facility is to determine parameters of the monitored vehicle by calculating an acceleration rate of the monitored vehicle in real time.

24. The system of claim 14, wherein the plurality of feature vectors comprise measurements detected by one or more sensors from the plurality of stationary sensors, wherein the one or more sensors are from a group consisting of a magnetic sensor, a vibration sensor, an acoustic sensor, a radar and a light sensor.

25. The system of claim 14, wherein the remote processing facility is to determine an identity of the monitored vehicle by matching the monitored vehicle with information related to the monitored vehicle received from an external source.

26. The system of claim 14, wherein tracking the trajectory of the monitored vehicle comprises analyzing the trajectory of the monitored vehicle for identifying road related information.
